(19) United States
(12) Patent Application Publication
(10) Pub. No.: US 2017/0057557 A1
(43) Pub. Date: Mar. 2, 2017

(54) Track System Plug

(71) Applicants: Clifford A. Moberg, Hartland, WI (US); John A. Veriha, Marinette, WI (US)

(72) Inventors: Clifford A. Moberg, Hartland, WI (US); John A. Veriha, Marinette, WI (US)

(21) Appl. No.: 15/250,584

(22) Filed: Aug. 29, 2016

Related U.S. Application Data
(60) Provisional application No. 62/211,460, filed on Aug. 28, 2015.

(51) Int. Cl. B62D 25/24

(52) U.S. Cl. CPC B62D 25/24; B60P 7/135

(57) ABSTRACT

A plug may be used in a receiver of a track system in order to prevent debris from filling the track. In order to keep the receiver clean, the plug preferably includes a generally planar base with a size of sufficient area to cover at least one receiver and prevent entry of debris into the track system. A mount prevents the plug from dislodging from the receiver. The mount includes a primary end with a primary clip and a secondary end with a secondary clip, each clip having a unique length. An overhang forms a space between the base and both the primary and secondary clips on opposing ends of the plug. The plug is positively retained in the receiver with an overhang on both the primary end and secondary end at least partially being displaced by the track system, thus pinching the track between the overhang on opposing ends of the plug.

### CROSS-REFERENCE TO RELATED APPLICATIONS

This application claims priority under 35 U.S.C. §119(e) to U.S. Provisional Patent Application No. 62/211,460, filed on Aug. 28, 2015, the entirety of each of which is expressly incorporated by reference herein.

### BACKGROUND OF THE INVENTION

1. Field of the Invention

The invention relates to the field of track systems for cargo securement. More specifically, the invention relates to a device to prevent track systems from becoming clogged with debris especially when not in use.

2. Discussion of the Related Art

Tractor trailers are used for transporting all kinds of goods, and different sized loads. A single, large object weighing many tons may completely fill the tractor trailer, or a plurality of smaller objects may also either partially or completely fill the trailer. In either case, in order to properly secure the objects during transportation, a load lock system may be used.

Load locks, also called load distribution bars or cargo load locks, are square bars with an extendible fitting on each end that locks into a track system mounted on the interior of a trailer. Load locks for trailers are commonly made of steel or high performance aluminum. When mounted, the load bars are secured to the track system installed on the interior walls of the trailer, and extend orthogonally to the tracks to fit the width of the trailer.

The track system consists of a plurality of female openings, or receivers, formed in steel or aluminum plate. The plate may be trimmed to any desired length and secured to the interior of the trailer with any known fastening device such as screws. The receivers in the plate may then accept a mating fastener such as the end of a load bar, a hook, or any other device made to mate with the receiver. Such a system is shown, for example, in FIG. 1.

In order to be fully prepared for any scenario, track systems may be installed in the interior of the trailer with hundreds of receiver holes for receiving mating fasteners in any conceivable configuration. While this allows for great flexibility in positioning of load bars, it also presents a problem. Debris can find its way into unused receiver holes thus preventing use when a load bar is attempted to be inserted into the respective receiver hole.

Debris may come in the form of dust or dirt, for example. Such debris may also be the actual object loaded into the trailer for transit. For example, the trailer may be loaded with mulch or loose gravel for delivery to a landscaping company. Undesirably, any loose material loaded into the trailer may find its way into an unused receiver hole.

When this happens, debris packed within the receiver hole of a track prevents insertion of a load bar. As a result, the debris requires removal, which is a time consuming endeavor. Pressurized air, vacuum, pressure washers, and the like are commonly used to clean debris from track systems. This introduces a costly and laborious step in preparing the trailer for its next job.

What is therefore needed is a solution to prevent unused receiver holes from becoming clogged with debris. Preferably, the solution would include a device that can be easily and securely inserted into a receiver hole to prevent debris from entering. The device should be held by the receiver holes firmly, but also be readily removable, including removable in large quantities, when the receiver hole is desired for use.

### SUMMARY OF THE INVENTION

To address the above-noted problems, a plug for a track system receiver is provided which includes a generally planar base of a size having sufficient area to cover at least one receiver. The base prevents entry of debris into the track system when the receiver is not in use. In order to keep the plug in place, a mount extends from a base of the plug and includes a primary end and a secondary end. The mount is designed to be inserted into the receiver. A primary clip of a first length extends from the primary end of the mount while a secondary clip of a second length extends from the secondary end of the mount. The second length is preferably less than the first length, which allows the plug to slide into place, thus locking it.

In order to lock the plug in the receiver, two separate overhangs form a space between the base and both the primary and secondary clips on opposing ends of the plug. The plug is positively retained in the receiver with the overhang on both the primary end and secondary end at least partially displaced by the track system.

A method of inserting the plug into the track system receiver is also disclosed herein. The plug may be inserted into the receiver by first inserting a primary clip of the plug into the receiver. Next, the primary clip may be slid along the receiver until the primary clip contacts at a first end of the receiver. By pivoting the plug to decrease an angle between the track system and the plug, the track may be fitted into the overhang of the primary clip. The overhang on the primary clip may be slid into place until the first end of the receiver contacts a throat on a primary end of the plug.

Pressing a top side of a base of the plug downwardly against the track system allows a secondary clip on a secondary end of the plug to fit into the receiver. Then, the plug may be slid toward a second end of the receiver after the secondary clip and the primary clip are both inserted into the receiver until a throat of the secondary end of the plug contacts the second end of the receiver. This places a portion of the track pinched between the base and overhang on opposing ends of the plug, positively retaining it in place.

Various other features, embodiments, and alternatives of the present invention will be made apparent from the following detailed description taken together with the drawings. It should be understood, however, that the detailed description and specific examples, while indicating preferred embodiments of the invention, are given by way of illustration and not limitation. Many changes and modifications could be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings, in which like reference numerals represent like parts throughout, and in which:

FIG. 1 shows a prior art tractor trailer employing a track system and load bars;

FIG. 2 is a perspective view of the plug according to a preferred embodiment of the invention;

FIG. 3 is a top view of the plug of FIG. 1;

FIG. 4 is a side view of the plug as shown in FIG. 1;

FIGS. 5A, 5B, and 5C show a side view of the progressive steps of installing the plug of FIG. 1 into a receiver of a track system, with the track system shown in a cross-sectional view;

FIG. 6 is a top view of the plug installed in a track system receiver as shown in FIG. 1; and

FIG. 7 is a top view of a track system of the prior art which receives the plug according to FIG. 1.

### DETAILED DESCRIPTION

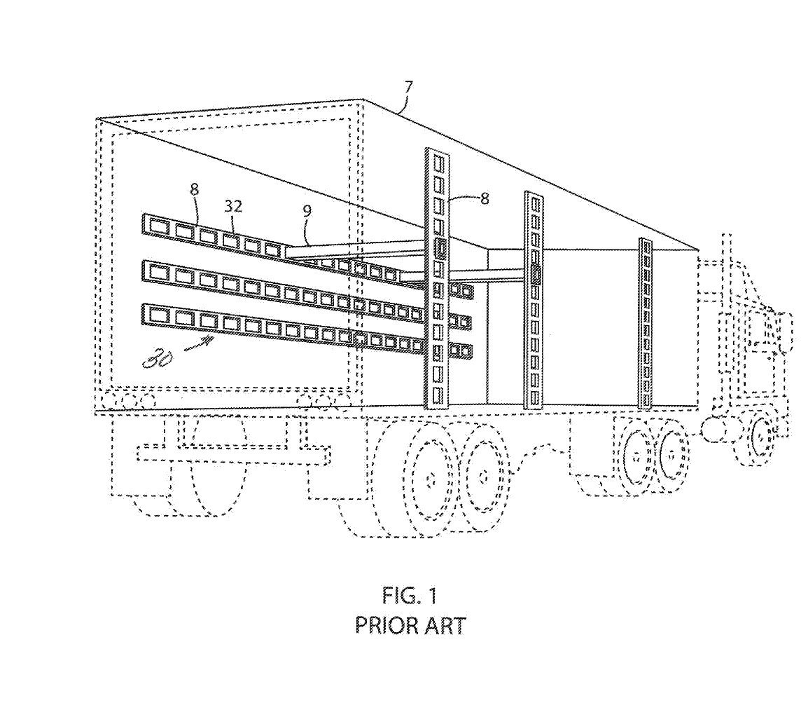

FIG. 1 shows a typical tractor trailer interior including a track system configured for securing cargo, such as an e-track system. A track system, or track 30 is commonly installed into the bed of a truck or a trailer 7 of a semi-truck, and may be powder coated, galvanized, zinc-plated, etc. See FIG. 7 for a more detailed view of a single receiver of track 30. Track 30 may be installed running horizontally parallel to the floor of the trailer or it may be installed vertically along the side walls of the trailer 7 as shown. Load bars 9 are inserted into the receiver holes, or receivers 32 of track 30 and used to prevent loads from moving during transit. In order to prevent debris from plugging up the unused receivers 34 in the track 30, the plug of the preferred embodiments may be used.

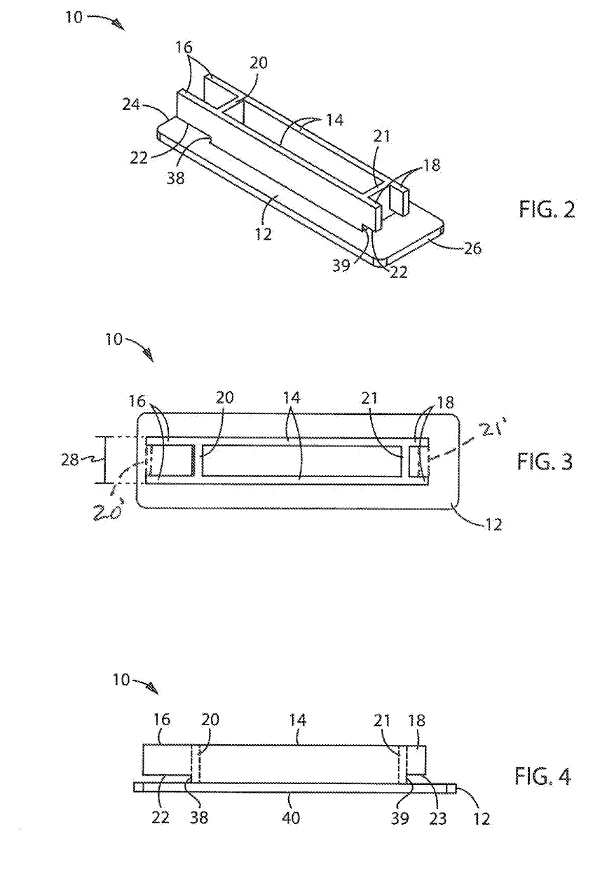

Referring to FIGS. 2-6, a plug 10 may be used to prevent debris from entering a receiver 32, as shown in FIG. 7. Plug 10 includes a mount 14 such as a retainer that extends from approximately a right angle of a base 12. The plug 10 has a primary end 24 and a secondary end 36. Primary clips 16 extend from the mount 14 on the primary end 24. The primary clips 16 help secure the plug in the receiver 32 with the use of an overhang 22 above the base. Similarly, on the secondary end 26, secondary clips 18 include an overhang 22.

As best shown in FIG. 3, the size of the overhang 22 should be of sufficient space between the respective clips 16, 18 to allow the thickness of the track 30 to fit within the overhang 22. This produces a frictional fit and prevents the plug 10 from falling out of the receiver 32. Research has shown that conventional tapered plugs fall out of the receiver 32. Known coverings such as tarps prove to be bulky and difficult to stow and keep clean. The inventive plug 10 therefore uses the primary clips 16 and the secondary clips 18 to positively retain the base 12 of the plug 10 against the track 30, thus preventing vibration, contact from debris, or accidental contact from removing the plug 10.

In FIG. 7, for example, an exemplary section of track 30 is shown. Such a track 30 may be mounted on the interior of a tractor trailer 7, see for example FIG. 1, with fasteners inserted through mount holes 42. A receiver 32 forms an opening that is configured to accept any number of implements with a mating securing device. When not in use, the receiver 32 may be covered with the plug 10, described in further detail below. While FIG. 7 shows a single receiver 32 in the track 30, FIG. 1 shows typical tracks that may include any number of receivers 32, up to or more than four hundred (400) in a typical installation. Also, while the receiver 32 is shown to be a rectangular opening in the track, it may be in the form of another shape, such as a rectangular opening with slots forming an “E” shaped opening, “T” shaped opening, “H” shaped opening, or the like.

The entire mount 14 is constructed with a width 28 such that it fits snugly into the receiver 32. The width 28 should not be oversized, but slight frictional contact with the receiver 32 is beneficial as it provides a secure fit.

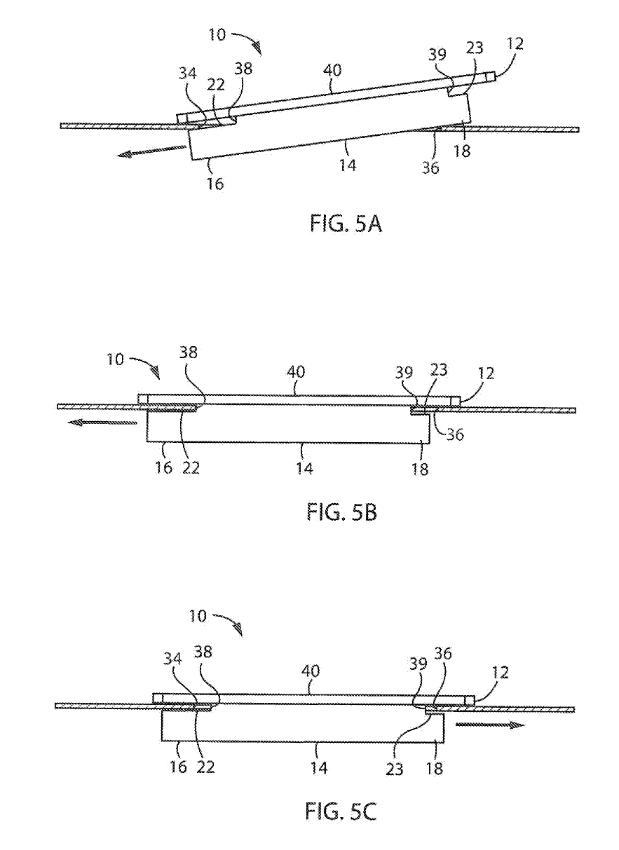

Referring now to FIGS. 5A through 5C, the plug 10 is inserted into the receiver 32 by first placing the primary end 24 proximate to the receiver 32 with the plug 10 at approximately a forty five degree angle, see for example FIG. 5A. The primary clips 16 may then be inserted into the receiver 32 and slid along the receiver 32 until the primary clips 16 contact the first end 34 of the receiver 32, as show in FIG. 5A. The plug 10 may then be pivoted to decrease the angle between the track 30 and the plug 10 while applying light pressure against the first end 34 with the primary clips 16, resulting in the base 12 of the plug being flush against the track system 30.

Following on to FIG. 5B, as the angle of the plug 10 and the track 30 is decreased, the first end 34 of the receiver 32 will slide into an overhang 22 of clip 16 until the first end 34 contacts the back of a throat 38 on one end 24 of plug 10. The top side 40 of the base 12 may then be pressed downwardly against the track 30 thus inserting the secondary clips 18 into the receiver 32.

As shown in FIG. 5C, after the secondary clips 18 and the primary clips 16 are both inserted into the receiver, the plug 10 may be slid toward the second end 36 of the receiver 32 until a back of a throat 39 of an overhang 23 of clip 18 at a secondary end 26 of the plug 10 contacts the second end 36 of the receiver 32. Once the throat 39 of clip 10 at secondary end 26 is in contact with the second end 36 of the receiver 32, the plug 10 is secured in place and may not be removed from the receiver 32 without performing the above steps in reverse. In this position, a portion of the track 30 remains inserted within the overhang 22 on both the primary end 24 and the secondary end of the plug 10. The overhang 22 therefore functions to pinch a portion of the track 30 between the base 12 and the respective clips 16, 18. The friction between the base 12, throat 38, and primary clips 16, and secondary clips 18 form a slight interference fit that locks the plug 10 within the receiver 32 with the use of friction. A plug 10 secured to receiver 32 (FIG. 7) is shown.

Preferably, the size of the rails of primary clip 16, secondary clip 18, the width 28 of the mount 14, and the size of the overhangs 22, 23 are all made such that there is a frictional fit with the receiver 32. Notably, the frictional fit should only be of sufficient magnitude to prevent unwanted moving of the plug 10 when inserted in the receiver 32. The frictional fit should be overcome with manual hand pressure sliding primary end 24 of plug 10 towards the first end 34 of receiver 32 and lifting up on secondary end 26 of the plug 10. In other words, the plug 10 is removed from the receiver 32 in the opposite manner as it was inserted and described above.

Plug 10 may be constructed out of any known material, such as plastic. The plastic may be fiber or glass infused, thermoset, thermoformed, machined from billet, injection molded, blow molded, or the like. The plug 10 may also be made out of rubber or have a coating 50, such as a rubberized coating or a coating to improve the ability of the mount to slide relative to the receiver. Alternatively, the plug may be made out of a metal or metal alloy with or without a coating, possibly to improve sliding properties. Finally, the plug may be made out of a natural material including wood. Plug 10 preferably is designed to elastically deform a minimal amount with manual pressure which allows greater manufacturing tolerances and increases the ease of insertion and removal in the receiver 32.

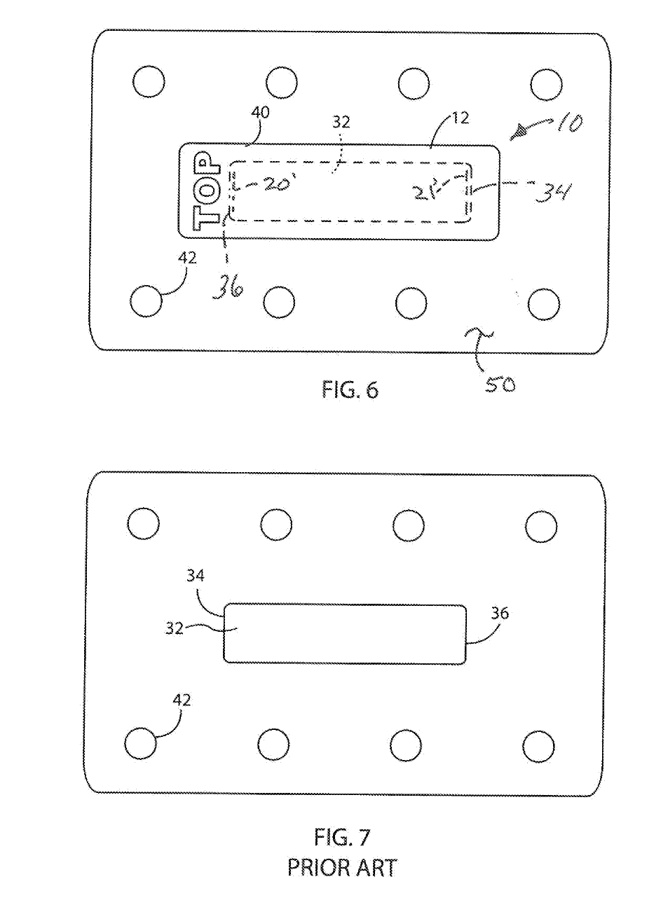

It is also conceived that magnets may be used in the construction of plug 10. As the track 30 is commonly made out of a ferrous material, a magnetic plug may facilitate the insertion, retention, and removal of the plug 10 from the receiver 32. In fact, magnets may eliminate the requirement of overhangs 22, 23, throats 38, 39, primary clips 16, and secondary clips 18 thus producing a “T” shaped cross section. Such a configuration would allow the plug 10 to be simply dropped into place by inserting the mount 14 into the receiver 32. The gussets 20, 21 on the mount 14 may be spaced apart such that they contact the first end 34 and second end 36 of the receiver 32, as shown by gussets 20′, 21′ illustrated in FIGS. 3 and 6. A magnet inserted on the base 12 would maintain the base 12 flush against the track 30.

In order to remove the magnetic plug 10, a magnetic removal tool may be used that attracts the magnetic plug. An operator could effortlessly remove the magnetic plug from the receiver 32 without bending over, or bending the plug itself. The plug may also be constructed on a roll with multiple plugs spaced at a predetermined distance for specific track designs.

Although the best mode contemplated by the inventors of carrying out the present invention is disclosed above, practice of the present invention is not limited thereto. It will be manifest that various additions, modifications, and rearrangements of the aspects and features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments.

1. A plug for a track system receiver comprising:
a generally planar base with a size of sufficient area to cover at least one receiver and prevent entry of debris into the track system;
a mount configured for insertion into the receiver with a primary end and a secondary end;
a primary clip of a first length extending from the primary end of the mount;
a secondary clip of a second length extending from the secondary end of the mount, wherein the second length is less than the first length;
an overhang forming a space between the base and both the primary and secondary clips; and
wherein the plug is positively retained in the receiver with the overhang on both the primary end and secondary end at least partially displaced by the track system.

2. The plug of claim 1 wherein the plug is made of at least one of plastic and rubber.

3. The plug of claim 1 wherein the plug includes rubber coating.

4. A plug for a track system receiver mounted in a semi trailer comprising:
a base configured to cover an opening forming the receiver and prevent a debris from entering the receiver; and
a mount extending from the base with means for securing the plug in the receiver.

5. The plug of claim 4, wherein the mount is a retainer.

6. The plug of claim 5, wherein the retainer is configured for insertion into the receiver with a primary end and a secondary end;
a primary clip of a first length extending from the primary end of the mount; and
a secondary clip of a second length extending from the secondary end of the mount, wherein the second length is less than the first length.

7. The plug of claim 6, wherein the retainer further includes an overhang forming a space between the base and both the primary and secondary clips; and
wherein the plug is positively retained in the receiver with the overhang on both the primary end and secondary end at least partially displaced by the track system.

8. The plug of claim 4, wherein at least one of the base and the mount is made of a magnetic material so as to retain the plug in the receiver.

9. The plug of claim 3 wherein the plug includes a coating to improve the ability of the mount to slide relative to the receiver.

10. The plug of claim 3 wherein the plug is made of at least one of a plastic, a rubber and metal.

11. A method of inserting a plug into a track system receiver comprising:
inserting a primary clip of the plug into the receiver;
sliding the primary clip along the receiver until the primary clip contacts a first end of the receiver;
pivoting the plug to decrease an angle between the track system and the plug;
applying a light pressure against the first end of the receiver with the primary clip;
sliding the first end of the receiver into an overhang of the primary clip until the first end of the receiver contacts a throat on a primary end of the plug;
pressing a top side of a base of the plug downwardly against the track system thus inserting a secondary clip on a secondary end of the plug into the receiver; and
sliding the plug toward a second end of the receiver after the secondary clip and the primary clip are both inserted into the receiver until a throat of the secondary end of the plug contacts the second end of the receiver.

12. The plug of claim 11 wherein the plug is made of at least one of a plastic, a rubber and metal.

13. The plug of claim 11 wherein the plug includes rubber coating.

14. The plug of claim 11 wherein the plug includes a coating to improve the ability of the mount to slide relative to the receiver.
